(19) United States
(12) Patent Application Publication
(10) Pub. No.: US 2006/0034327 A1
(43) Pub. Date: Feb. 16, 2006

(54) Communication device

(75) Inventor: Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 11/198,134

(22) Filed: Aug. 8, 2005

(30) Foreign Application Priority Data
Aug. 11, 2004 (JP) 2004-234507

(51) Int. Cl. H04J 3/16

(52) U.S. Cl. 370/466; 370/401

(57) ABSTRACT

When receiving an incoming call by a call control protocol, a communication device selects a terminal device to be connected according to a media type of data communication requested by a caller, without being limited to a type of a protocol of packet data, and establishes a connected between the caller and the terminal device. The communication device includes a table and a control unit. The table stores media type information and calling order information by associating each with one another for each terminal device to be the connection destination. When receiving a session participation request by the Session Initiation Protocol (SIP) from a remote device, the control unit controls communication between one or a plurality of terminal devices, which are stored by being associated with the media type information detected from proposal information relating to a media session received simultaneously, and the remote device in accordance with the calling order information stored by being associated with the terminal devices.

### BACKGROUND OF THE INVENTION

1. Field of the Invention

The present invention relates to a communication device which selects a terminal device to be connected according to a media type of data communication requested by a caller device when receiving an incoming call by a call control protocol such as the Session Initiation Protocol (SIP) and establishes a connection between the selected terminal device and the caller device.

2. Description of Related Art

Recently, communication devices, which transmit and receive voice data and image data through an Internet Protocol (IP) network such as an IP telephone communication and an IP facsimile communication, are becoming widespread. A proposal is made on a communication device, which carries out a data communication for both the voice data and the image data.

Such a communication device includes a function for establishing a connection by switching a telephone set and a facsimile machine according to whether packet data received from a Local Area Network (LAN) interface via the Internet is the User Datagram Protocol (UDP) or the Transmission Control Protocol (TCP).

However, a protocol of an incoming call is not limited to the UDP or the TCP and a terminal device to be connected cannot be selected. That is, there exists a drawback that the communication device cannot select a connection destination that is most suitable for a media type of data communication requested by a caller.

### SUMMARY OF THE INVENTION

The present invention has been made in consideration of the above-described circumstances. An advantage of the present invention is to provide a communication device which can select a terminal device to be connected according to a media type of data communication requested by a caller, without being limited to a type of protocol of packet data, and establishes a connection between the selected terminal device and the caller when receiving an incoming call by a call control protocol.

According to an aspect of the present invention, a communication device includes a storage unit, a detecting unit and a control unit. The storage unit stores media type information and calling order information by associating each with one another for each terminal device to be a connection destination. When receiving a connection request by a call control protocol from a remote device, the detecting unit detects the media type information from information received along with the connection request. The control unit controls communication between one or a plurality of terminal devices, which are stored by being associated with the detected media type information, and the remote device in accordance with the calling order information stored by being associated with the terminal devices.

### BRIEF DESCRIPTION OF THE SEVERAL VIEWS OF THE DRAWINGS

FIG. 1 shows an example of a configuration of a communication device and an example of a network configuration where the communication device is installed according to an embodiment of the present invention.

FIG. 2 shows an example of a table which stores media type information, a terminal device and calling order information by associating each with one another.

FIG. 3 shows an example of media type information described after a SIP header by the Session Description Protocol (SDP).

FIG. 4 is a flowchart showing a processing operation executed when the communication device receives a connection request by the SIP from an IP network according to an embodiment of the present invention.

FIG. 5 is a flowchart showing a processing operation executed when the communication device receives a connection request by the SIP from an IP network according to an embodiment of the present invention.

### DETAILED DESCRIPTION OF THE INVENTION

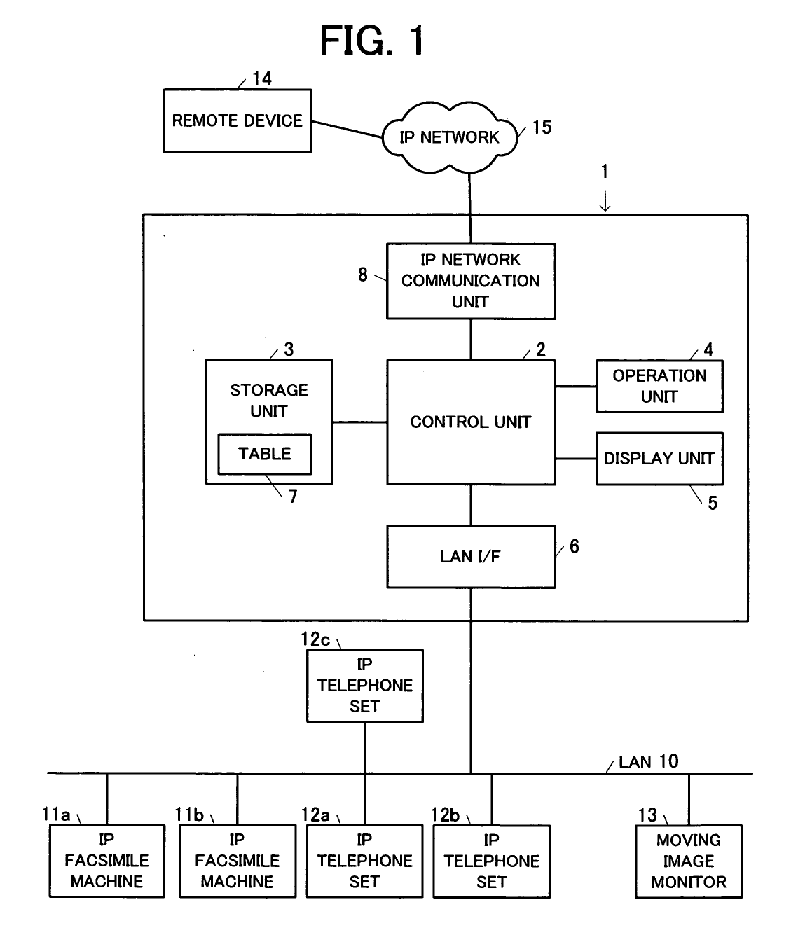

With reference to the drawings, a description will be made of a communication device according to an embodiment of the present invention. FIG. 1 shows an example of a configuration of a communication device 1 and an example of a network where the communication device 1 is connected according to an embodiment of the present invention. As shown in the drawing, the communication device 1 includes a control unit 2, a storage unit 3, an operation unit 4, a display unit 5, a LAN interface 6 and an IP network connection unit 8.

The control unit 2 includes a Central Processing Unit (CPU), a Read Only Memory (ROM) storing a control program and a Random Access Memory (RAM) or the like. The control unit 2 controls each of the units of the communication device 1. The storage unit 3 is formed of a RAM or the like and stores a table 7 to be described later. The operation unit 4 includes an input unit such as a keyboard and a mouse. The operation unit 4 accepts an input of information designated by an operation of a user. The display unit 5 is a Liquid Crystal Display (LCD) monitor or the like and displays various pieces of screen information in accordance with a command from the control unit 2.

The LAN interface 6 is an interface which establishes a connection between the communication device 1 and a LAN 10. The communication device 1 carries out communication through the LAN interface 6 with IP facsimile machines 11a and 11b, IP telephone sets 12a and 12b and a moving image monitor 13 or the like, which are also connected to the LAN 10. The IP network communication unit 8 controls a connection with an IP network 15 such as the Internet and an Intranet.

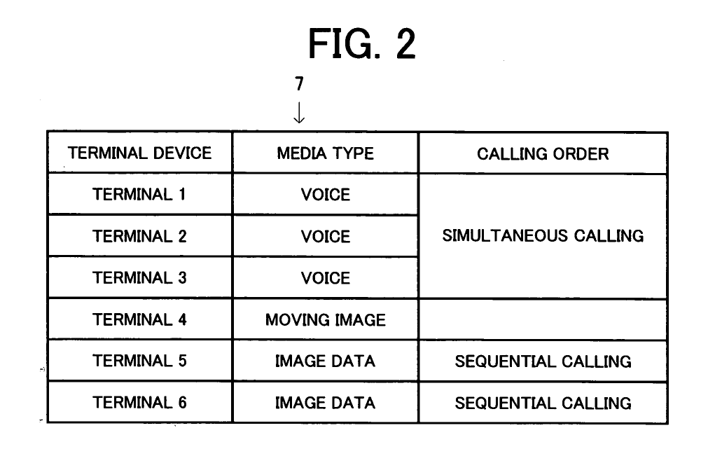

A table stored in the storage unit 3 stores a correspondence relationship between media type information and calling order information for each terminal device to be a connection destination. The contents of the table that stores such a correspondence relationship are displayed on the display unit 5 by a prescribed operation from the operation unit 4 so that an edition processing such as inputting, deleting and changing can be carried out. As the table that stores the correspondence relationship, for example, a table 7 shown in FIG. 2 is stored in the storage unit 3. The table 7 includes a “terminal device” field, a “media type” field and a “calling order” field. Information stored in the same record of each field is associated with one another. The “terminal device” field stores information that specifies a terminal device. The “media type” field stores media type information. In the “media type” field, information that designates three kinds of media types, i.e. voice, a moving image and image data (a still image), can be set. In the “calling order” field, information that designates either one of simultaneous calling and sequential calling is set. As shown in the table 7 of FIG. 2, when media type information of one record does not overlap with the media type information of other records, the “calling order” field of such a record can be null.

In the present embodiment, the media type information designating the voice data (in the drawing, “voice”) and the calling order information designating the simultaneous calling of all of the terminal devices (in the drawing, “simultaneous calling”) are stored by being associated with a “terminal 1” through a “terminal 3”, which corresponds to the IP telephone sets 12a through 12c (telephone sets which can carry out IP communication). The media type information designating the moving image data (in the drawing, “moving image”) is stored by being associated with a “terminal 4”, which corresponds to the moving image monitor 13. The media type information designating the still image data (in the drawing, “image data”) and the calling order information designating the sequential calling of corresponding terminal devices (in the drawing, “sequential calling”) are stored by being associated with a “terminal 5” and a “terminal 6”, which correspond to the IP facsimile machines 11a and 11b (facsimile machines which can carry out the IP communication).

The above-described communication device 1 is embedded with the UDP/IP, the TCP/IP, the SIP, the SDP or the like. When the communication device 1 receives a connection request by a call control protocol from a remote device 14 through a SIP server (not shown), the communication device 1 detects media type information from information received along with the connection request. Then, the communication device 1 refers to the table 7 stored in the storage unit 3 and controls the communication between one or a plurality of the terminal devices, which are stored by being associated with the detected media type information, and the remote device 14 in accordance with the calling order information stored by being associated with the terminal devices. In the following, a description will be made of the processing operation of the communication device 1.

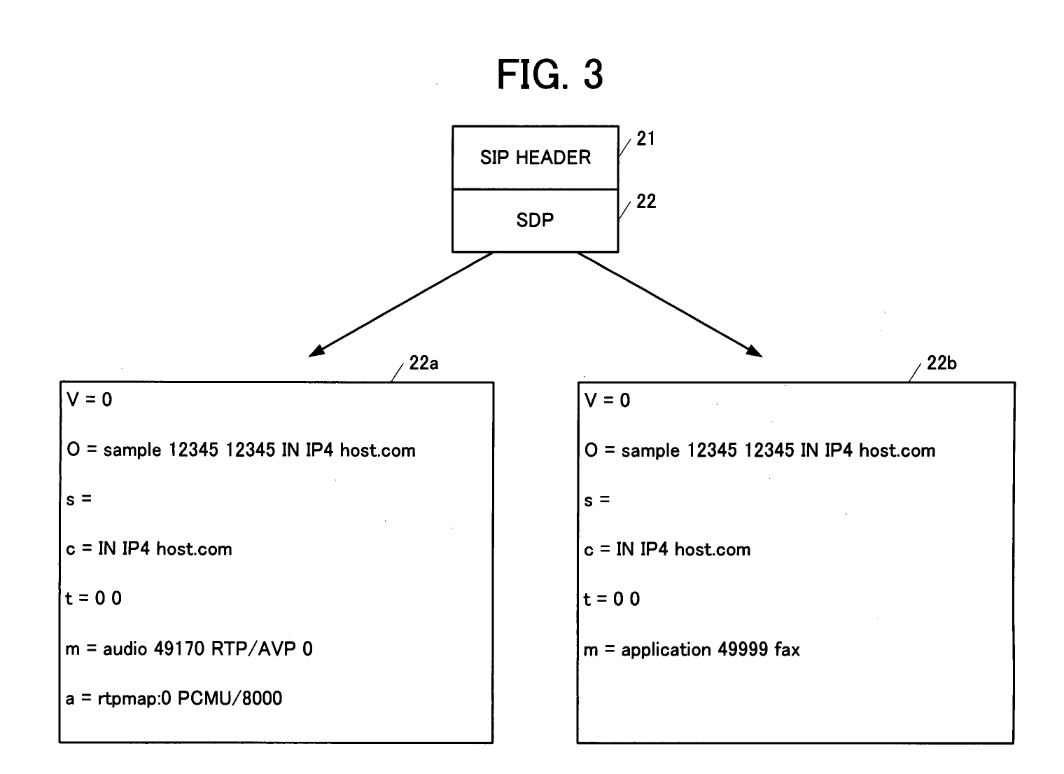

As shown in FIG. 3, when the communication device 1 receives a session participation request “INVITE” as a connection request from the remote device 14, the control unit 2 detects media type information from the received information, which is described by the SDP in a message body part subsequent to a SIP header. For example, as shown in FIG. 3, the control unit 2 analyzes information described in a row “m”, which indicates the media type information of proposal information 22 (22a, 22b) relating to the media session described after a SIP header 21. Then, the control unit 2 detects the media type information proposed by the remote device 14. For example, as shown in the proposal information 22a shown in FIG. 3, when “audio 49170 RTP/AVP 0” is described in the row “m”, “audio” is detected as the media type information designating the voice data. As shown in the proposal information 22b, when “application 49999 fax” is described in the row “m” as the media type information, “fax” is detected as the media type information designating the still image data. Although not shown in the drawing, when “video 4004RTP/AVP 14 26” or the like is described in the row “m” as the media type information, “video” is detected as the media type information designating the moving image data. Further, in the proposal information 22a, “49170” indicates a receiving port number, and “RTP/AVP 0” indicates a type and a payload type value of a transport protocol. In the proposal information 22b, “49999” indicates a receiving port number.

The control unit 2, which detected the media type information, refers to the table 7 and executes a call processing to one or a plurality of the terminal devices associated with the detected media type information. When a plurality of terminal devices associated with the detected media type information exist in the table 7, a calling order is decided in accordance with the calling order information associated with each of the terminal devices. That is, when the calling order information is the simultaneous calling, the call processing is executed simultaneously to the corresponding terminal devices. When the calling order information is the sequential calling, the call processing is executed sequentially to the corresponding terminal devices. Further, in the present embodiment, the sequential call processing is carried out in order of rows of the records of the table for the corresponding terminal devices. However, the order of the call processing carried out to the terminal devices is not limited to the above-described example. For example, information specifying a calling order, for example, a number, can be stored in the calling order field of the table 7 and the call processing can be carried out sequentially in accordance with the stored information.

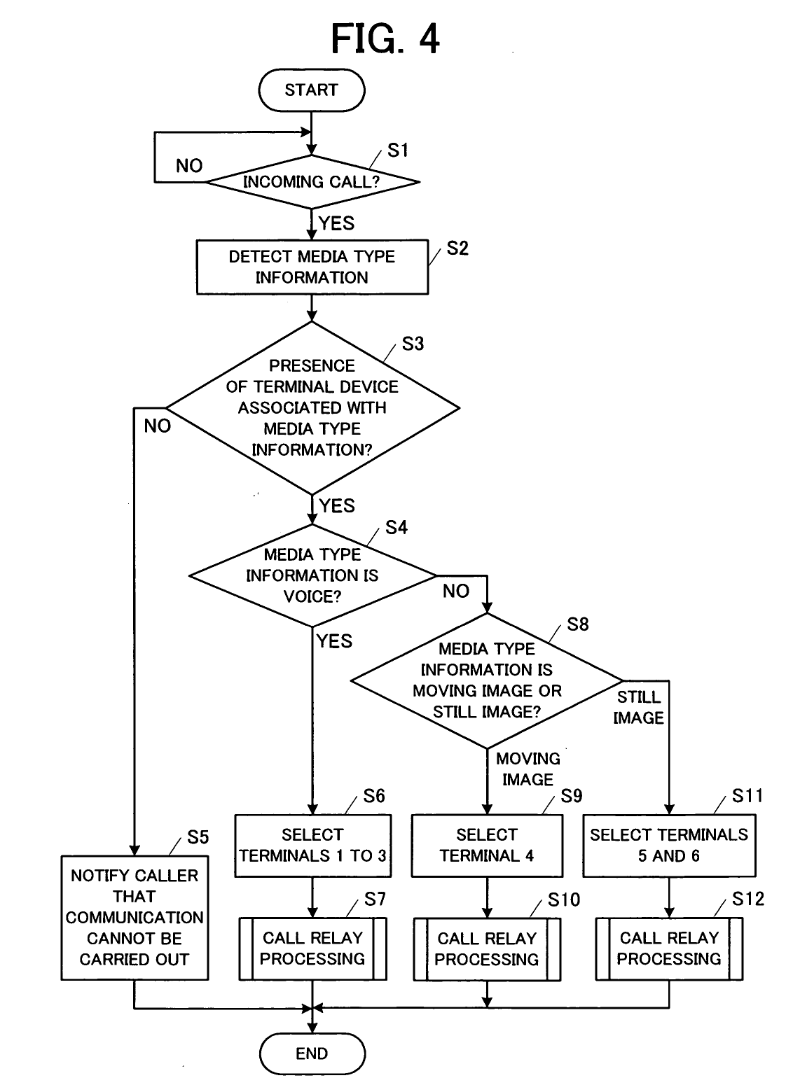

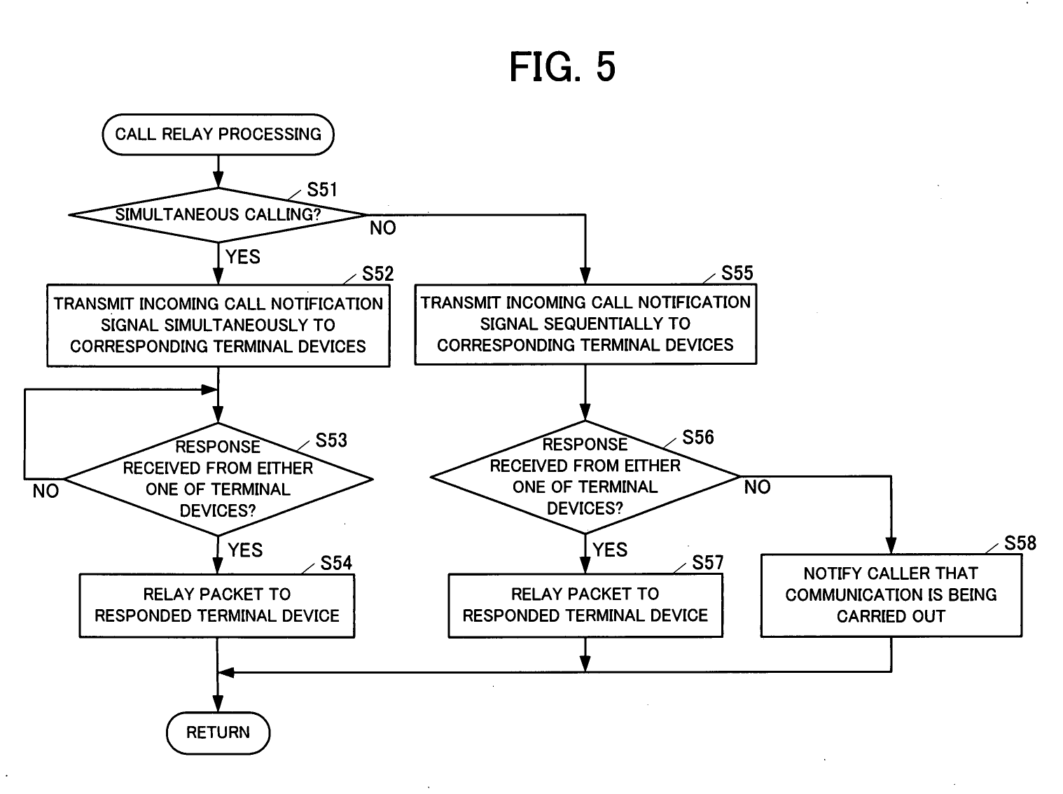

Next, referring to the flowcharts shown in FIG. 4 and FIG. 5, a description will be made of the processing operation executed when the communication device 1 receives a connection request from the remote device 14.

First, when the control unit 2 of the communication device 1 receives “INVITE” as the connection request from the remote device 14 (S1: YES), the control unit 2 detects the media type information from the information described by the SDP in a part subsequent to the SIP header of “INVITE” (S2).

Next, the control unit 2 refers to the table 7 stored in the storage unit 3 and determines whether or not the detected media type information and the terminal device associated with the detected media type information are stored in the table 7 (S3). When the control unit 2 determines that the terminal device associated with the detected media type information is not stored (S3: NO), the control unit 2 notifies the remote device 14, which is a caller, that the communication cannot be carried out (S5). For example, the control unit 2 notifies such a fact by returning a specific response code of the SIP to the remote device 14.

When the control unit 2 determines that the terminal device associated with the detected media type information is stored (S3: YES) and the detected media type information is the information designating the voice data (S4: YES), the control unit 2 selects the terminal devices associated with the information designating the voice data in the table 7 as calling destinations. For example, when the communication device 1 stores the table 7 shown in the drawing, the control unit 2 selects the “terminal 1” through the “terminal 3” as the calling destinations (S6). Then, the call processing is executed to the selected terminal devices in accordance with the calling order information associated with the selected terminal devices, and the communication device 1 relays a packet transmitted from the remote device 14, which is the caller, to the terminal devices, which responded to the call processing (S7).

That is, as shown in the flowchart of FIG. 5, the control unit 2 of the communication device 1 refers to the table 7 stored in the storage unit 3 and determines whether the calling order information associated with the terminal devices is the information designating the simultaneous calling of the plurality of the terminal devices (S51). When the calling order information is the simultaneous calling information (S51: YES), the control unit 2 carries out the call processing to all of the corresponding terminal devices simultaneously (S52). When there exists one corresponding terminal device, the call processing is carried out only to the corresponding one terminal device. For example, the call processing is carried out by transmitting an incoming call notification signal. When either one of the terminal devices responds to the call processing (S53: YES), the control unit 2 of the communication device 1 relays a packet received from the remote device 14 to the responded terminal device and establishes a connection between the responded terminal device and the remote device 14 (S54).

At S51, when the calling order information associated with the terminal devices to be called is determined to be not designating the simultaneous calling (S51: NO), the call processing is carried out sequentially to the corresponding terminal devices (the terminal devices associated with the media type information detected at S2) (S55). When there exists one corresponding terminal device, the call processing is carried out only to the corresponding one terminal device. The call processing is carried out to the corresponding terminal devices in the order of the records of the table 7 for a predetermined period of time, respectively. For example, the call processing is carried out by sequentially transmitting the incoming call notification signal to the corresponding terminal devices. When either one of the terminal devices responds to the call processing (S56: YES), the control unit 2 of the communication device 1 relays a packet received from the remote device 14 to the responded terminal device and establishes a connection between the responded terminal device and the remote device 14 (S57). Further, when there is no response from the called terminal device or when the called terminal device is during communication, the sequential call processing of S55 carries out the call processing to the next terminal device sequentially.

Meanwhile, at S56, when neither one of the terminal devices responds to the call processing (S56: NO), the control unit 2 ends the call processing and notifies the remote device 14, which is the caller, that communication is being carried out (S58). For example, the control unit 2 can carry out the notification by returning a specific response code of the SIP to the remote device 14.

Meanwhile, when the control unit 2 determines at S4 that the detected media type information is not the information designating the voice data (S4: NO) and determines at S8 that the detected media type information is the information designating the moving image (S8: moving image), the control unit 2 selects the terminal device associated with the information designating the moving image data in the table 7 as a calling destination. For example, when the communication device 1 stores the table 7 shown in the drawing, the control unit 2 selects the “terminal 4” as the calling destination (S9). The control unit 2 executes the call processing to the selected terminal device in accordance with the calling order information associated with the selected terminal device, and relays a packet transmitted from the remote device 14, which is the caller, to the terminal device, which responded to the call processing (S10). That is, the communication device 1 executes the processing operations of S51 through S58 to the corresponding terminal device.

At S8, when the control unit 2 determines that the detected media type information is the information designating the still image data (S8: still image), the control unit 2 selects the terminal device associated with the information designating the still image data in the table 7 as the calling destination. For example, when the communication device 1 stores the table 7 shown in the drawing, the control unit 2 selects the “terminal 5” and the “terminal 6” as the calling destinations (S11). The control unit 2 executes the call processing to the selected terminal devices in accordance with the calling order information associated with the selected terminal devices, and relays a packet transmitted from the remote device 14, which is the caller, to the terminal devices, which responded to the call processing (S12). That is, the communication device 1 executes the processing operations of S51 through S58 to the corresponding terminal devices.

Next, a description will be made of a specific example of the processing operations of S51 through S58 executed by the communication device 1 when the table 7 as shown in FIG. 2 is formed in the storage unit 3.

As shown in the table 7 of FIG. 2, the media type information designating the voice data and the calling order information designating the simultaneous calling are stored by being associated with the “terminal 1” through the “terminal 3” corresponding to the IP telephone sets 12a through 12c. Therefore, when the media type information detected at S2 designates the voice data, the processing operations of S3, S4 and S6 are carried out and a positive determination is made at S51. Then, at S52, the call processing is carried out simultaneously to three telephone sets, i.e. the IP telephone sets 12a through 12c (The incoming call notification signal is transmitted simultaneously to the IP telephone sets 12a through 12c). When the simultaneous call processing is carried out, the three IP telephone sets ring a ringing bell simultaneously. When the user carries out a response operation, for example, when the user picks up a receiver of either one of the IP telephone sets, a response signal is transmitted from the responded IP telephone set to the communication device 1. When the communication device 1 receives the response signal from either one of the IP telephone sets (S53: YES), the control unit 2 of the communication device 1 relays a packet to the responded IP telephone set and establishes a connection between the responded IP telephone set and the remote device 14 (S54).

As shown in the table 7 of FIG. 2, the media type information designating the moving image data is stored by being associated with the “terminal 4” corresponding to the moving image monitor 13. Therefore, when the media type information detected at S2 designates the moving image data, the processing operations for the moving image of S3, S4 and S8 are carried out and a negative determination is made at S51. At S55, the call processing is carried out to the moving image monitor 13. When the moving image monitor 13 responds to the call processing (S56: YES), the control unit 2 relays a packet to the responded moving image monitor 13 and establishes a connection between the moving image monitor 13 and the remote device 14 (S57). Meanwhile, when the moving image monitor 13 does not respond, in other words, when the moving image monitor 13 does not return a response signal, the control unit 2 ends the call processing and notifies the remote device 14, which is the caller, that the communication is being carried out (S58).

As shown in the table 7 of FIG. 2, the media type information designating the still image data and the calling order information designating the sequential calling are stored by being associated with the “terminal 5” and the “terminal 6” corresponding to the IP facsimile machines 11a and 11b. Therefore, when the media type information detected at S2 designates the still image data, the processing operations for the still image data of S3, S4 and S8 are carried out and a negative determination is made at S51. Then, at S55, the call processing is carried out sequentially to two IP facsimile machines 11a and 11b for a predetermined period of time, respectively. For example, first, the call processing is carried out (the incoming call notification signal is transmitted) to the IP facsimile machine 11a for ten seconds. When the IP facsimile machine 11a does not respond, the call processing is carried out to the IP facsimile machine 11b. When either one of the IP facsimile machines responds to the call processing (S56: YES), the control unit 2 of the communication device 1 relays a packet to the responded IP facsimile machine and establishes a connection between the responded IP facsimile machine and the remote device 14 (S57). Meanwhile, when neither one of the IP facsimile machines responds, in other words, when neither one of the IP facsimile machines returns the response signal, the control unit 2 ends the call processing and notifies the remote device 14, which is the caller, that the communication is being carried out (S58).

In the above-described embodiment, a description is made of an example in which the SIP is the call control protocol. However, if the call control protocol can receive the media type information along with the connection request, another call control protocol can be adopted. Moreover, in the above-described embodiment, a description is made of an example in which the media type information received along with the connection request is described by the SDP. However, if the media type information proposed by the caller along with the connection request can be detected, the description method is not limited to the SDP. Moreover, the voice data, the moving image data and the still image data are described as examples of the media type information. However, other media type information may be adopted.

As described above, according to the communication device 1 of the embodiment of the present invention, without the packet data received by the call control protocol being limited to the UDP or the TCP, the terminal device appropriate to the media type requested by the remote device 14, which is the caller, can be selected automatically, and a connection can be established between the remote device 14 and the selected terminal device. For example, regardless of whether the received packet data is the UDP or the TCP, when the remote device 14 requests the voice communication, the communication device 1 can establish a connection between the remote device 14 and an IP telephone set, which is capable of carrying out the voice communication, and when the remote device 14 requests the still image data communication, the communication device 1 can establish a connection between the remote device 14 and an IP facsimile machine.

In an office where a plurality of IP telephone sets are installed, an incoming call of an IP telephone is preferably replied by either one of the IP telephone sets. According to the present invention, the media type information designating the voice data and the calling order information designating the simultaneous calling are registered by being associated each with one another in all of the IP telephone sets. As a result, an incoming call of an IP telephone can be replied by either one of the IP telephone sets.

In an office where a plurality of IP telephone sets are installed, a call processing is preferably carried out in order to the IP facsimile machines one at a time and a connection is preferably established between the responded IP facsimile machine and the caller. According to the present invention, the media type information designating the still image data and the calling order information designating the sequential calling can be registered by being associated each with one another in the plurality of the IP facsimile machines. As a result, the call processing can be carried out in order to the IP facsimile machines one at a time and a connection can be established between the responded IP facsimile machine and the caller.

1. A communication device, comprising:
means for storing media type information and calling order information by associating each with one another for each terminal device to be a connection destination;
means for detecting, when receiving a connection request by a call control protocol from a remote device, media type information from information received along with the connection request; and
means for controlling communication between one or a plurality of terminal devices stored by being associated with the detected media type information and the remote device in accordance with the calling order information stored by being associated with the terminal devices.

2. The communication device according to claim 1, wherein the calling order information includes simultaneous calling designation information designating a simultaneous calling of the plurality of the terminal devices; and
when the calling order information is the simultaneous calling designation information, the means for controlling carries out a call processing simultaneously to all of the corresponding terminal devices.

3. The communication device according to claim 1, wherein the calling order information includes sequential calling designation information designating a sequential calling of the plurality of the terminal devices; and
when the calling order information is the sequential calling designation information, the means for controlling carries out a call processing sequentially to the corresponding terminal devices.

4. A communication device control method, comprising:
a storing step of storing media type information and calling order information by associating each with one another for each terminal device to be a connection destination;
a detecting step of, when receiving a connection request by a call control protocol from a remote device, media type information from information received along with the connection request; and
a control step of controlling communication between one or a plurality of terminal devices stored by being associated with the detected media type information and the remote device in accordance with the calling order information stored by being associated with the terminal devices.

5. The communication device control method according to claim 4, wherein the calling order information includes simultaneous calling designation information designating a simultaneous calling of the plurality of the terminal devices; and
when the calling order information is the simultaneous calling designation information, the control step carries out a call processing simultaneously to all of the corresponding terminal devices.

6. The communication device control method according to claim 4, wherein the calling order information includes sequential calling designation information designating a sequential calling of the plurality of the terminal devices; and
when the calling order information is the sequential calling designation information, the control step carries out a call processing sequentially to the corresponding terminal devices.
